(19) United States
(12) Patent Application Publication
(10) Pub. No.: US 2025/0193163 A1
(43) Pub. Date: Jun. 12, 2025

(54) Aggregating secured packets in a network device

(71) Applicant: Mellanox Technologies, Ltd., Yokneam (IL)

(72) Inventors: Boris Pismenny, Chavannes pres Renens (CH); Miriam Menes, Tel Aviv (IL)

(21) Appl. No.: 18/741,851

(22) Filed: Jun. 13, 2024

(30) Foreign Application Priority Data
Dec. 6, 2023 (IL) 309163

(51) Int. Cl. H04L 9/40; H04L 69/22

(52) U.S. Cl. CPC H04L 63/0485; H04L 69/22; H04L 2212/00

(57) ABSTRACT

In one embodiment, a network device includes a network interface to receive secured packets from a remote device over a packet data network, each of the secured packets being secured according to a security protocol and including a respective security protocol header and a Transmission Control Protocol (TCP) packet, which is encrypted according to the security protocol, a host device interface to connect the network device to a host device, and packet processing circuitry to decrypt each of the secured packets based on the respective security protocol header yielding multiple decrypted packets including decrypted TCP packets, aggregate the decrypted TCP packets into a single aggregated packet, and provide the single aggregated packet to software running on a processor of the host device via the host device interface.

### FIELD OF THE INVENTION

The present invention relates to computer systems, and in particular, but not exclusively to, aggregation of secured packets.

### BACKGROUND

Large Receive Offload (LRO) or packet aggregation is a performance optimization technique that reduces central processing unit (CPU) overhead for processing packets that arrive from the network at a high rate. With LRO, hardware, e.g., in a network device, aggregates received packets into aggregated packets, and the networking code in the kernel fetches the aggregated packets, and processes the aggregated packets as respective units. LRO reassembles incoming network packets into larger buffers and transfers the resulting larger but fewer packets to the network stack of the host or virtual machine. By doing so, LRO reduces the number of packets that the CPU has to process, which in turn reduces its utilization for networking. This is especially useful for connections that have high bandwidth.

### SUMMARY

There is provided in accordance with an embodiment of the present disclosure, a network device, including a network interface to receive secured packets from a remote device over a packet data network, each of the secured packets being secured a security protocol and including a respective security protocol header and a Transmission Control Protocol (TCP) packet, which is encrypted the security protocol, a host device interface to connect the network device to a host device, and packet processing circuitry to decrypt each of the secured packets based on the respective security protocol header yielding multiple decrypted packets including decrypted TCP packets, aggregate the decrypted TCP packets into a single aggregated packet, and provide the single aggregated packet to software running on a processor of the host device via the host device interface.

Further in accordance with an embodiment of the present disclosure the aggregated packet is encapsulated with a given security protocol header and a given TCP header.

Still further in accordance with an embodiment of the present disclosure the packet processing circuitry is to scatter the single aggregated packet to a memory of the host device accessible by the software.

Additionally in accordance with an embodiment of the present disclosure the packet processing circuitry is to scatter the single aggregated packet to the memory a memory location given by a work queue entry consumed by the single aggregated packet.

Moreover, in accordance with an embodiment of the present disclosure the security protocol is a per packet encryption protocol.

Further in accordance with an embodiment of the present disclosure the security protocol is any one of the following Internet Protocol Security (IPsec), PSP Security Protocol, Datagram Transport Layer Security (DTLS), or Media Access Control Security (MACSec).

Still further in accordance with an embodiment of the present disclosure packet processing circuitry is to check that sequence numbers of the multiple decrypted packets form a sequence of consecutive numbers, and aggregate the decrypted TCP packets into the single aggregated packet responsively to the sequence numbers of the multiple decrypted packets forming a sequence of consecutive numbers.

Additionally in accordance with an embodiment of the present disclosure the packet processing circuitry is to check that the sequence numbers in security protocol headers and TCP headers of the decrypted packets form respective sequences of consecutive numbers, and aggregate the decrypted TCP packets into the single aggregated packet responsively to the sequence numbers in the security protocol headers and the TCP headers of the multiple decrypted packets forming respective sequences of consecutive numbers.

Moreover, in accordance with an embodiment of the present disclosure the packet processing circuitry is to generate metadata about the number of decrypted TCP packets included in the single aggregated packet, and provide the metadata to the software running on the processor of the host device.

Further in accordance with an embodiment of the present disclosure the packet processing circuitry is to generate the metadata with an indication of the sequence numbers of the decrypted packets included in the single aggregated packet.

Still further in accordance with an embodiment of the present disclosure the packet processing circuitry is to receive an offload of cryptographic material from the software running on the processor of the host device, and decrypt the TCP packet of each of the secured packets based on the respective security protocol header and the offloaded cryptographic material yielding the decrypted TCP packets.

There is also provided in accordance with another embodiment of the present disclosure, a system including the network device of, and the host device, wherein the software is to receive the single aggregated packet, and decapsulate the given security protocol header from the aggregated packet.

Additionally in accordance with an embodiment of the present disclosure the software is to update a replay protection map based on security protocol sequence numbers of the decrypted packets included in the single aggregated packet.

Moreover, in accordance with an embodiment of the present disclosure the software is to derive the security protocol sequence numbers from metadata of the single aggregated packet, or header data of the single aggregated packet and a number of decrypted packets included in the single aggregated packet.

There is also provided in accordance with still another embodiment of the present disclosure, a method, including receiving secured packets from a remote device over a packet data network, each of the secured packets being secured a security protocol and including a respective security protocol header and a Transmission Control Protocol (TCP) packet, which is encrypted the security protocol, decrypting each of the secured packets based on the respective security protocol header yielding multiple decrypted packets including decrypted TCP packets, aggregating the decrypted TCP packets into a single aggregated packet, and providing the single aggregated packet to software running on a processor of a host device via a host device interface.

Further in accordance with an embodiment of the present disclosure the aggregated packet is encapsulated with a given security protocol header and a given TCP header.

Still further, in accordance with an embodiment of the present disclosure, the method includes scattering the single aggregated packet to a memory of the host device accessible by the software.

Additionally in accordance with an embodiment of the present disclosure the scattering includes scattering the single aggregated packet to the memory a memory location given by a work queue entry consumed by the single aggregated packet.

Moreover, in accordance with an embodiment of the present disclosure the security protocol is a per packet encryption protocol.

Further in accordance with an embodiment of the present disclosure the security protocol is any one of the following Internet Protocol Security (IPsec), PSP Security Protocol, Datagram Transport Layer Security (DTLS), or Media Access Control Security (MACSec).

Still further in accordance with an embodiment of the present disclosure, the method includes checking that sequence numbers of the multiple decrypted packets form a sequence of consecutive numbers, and wherein the aggregating includes aggregating the decrypted TCP packets into the single aggregated packet responsively to the sequence numbers of the multiple decrypted packets forming a sequence of consecutive numbers.

Additionally in accordance with an embodiment of the present disclosure the checking includes checking that the sequence numbers in security protocol headers and TCP headers of the decrypted packets form respective sequences of consecutive numbers, and the aggregating includes aggregating the decrypted TCP packets into the single aggregated packet responsively to the sequence numbers in the security protocol headers and the TCP headers of the multiple decrypted packets forming respective sequences of consecutive numbers.

Moreover, in accordance with an embodiment of the present disclosure, the method includes generating metadata about the number of decrypted TCP packets included in the single aggregated packet, and providing the metadata to the software running on the processor of the host device.

Further in accordance with an embodiment of the present disclosure the generating includes generating the metadata with an indication of the sequence numbers of the decrypted packets included in the single aggregated packet.

Still further in accordance with an embodiment of the present disclosure, the method includes receiving an offload of cryptographic material from the software running on the processor of the host device, wherein the decrypting includes decrypting the TCP packet of each of the secured packets based on the respective security protocol header and the offloaded cryptographic material yielding the decrypted TCP packets.

Additionally in accordance with an embodiment of the present disclosure, the method includes receiving the single aggregated packet, and decapsulating the given security protocol header from the aggregated packet.

Moreover, in accordance with an embodiment of the present disclosure, the method includes updating a replay protection map based on security protocol sequence numbers of the decrypted packets included in the single aggregated packet.

Further in accordance with an embodiment of the present disclosure the software is to derive the security protocol sequence numbers from metadata of the single aggregated packet, or header data of the single aggregated packet and a number of decrypted packets included in the single aggregated packet.

### BRIEF DESCRIPTION OF THE DRAWINGS

The present invention will be understood from the following detailed description, taken in conjunction with the drawings in which:

FIG. 1 is a block diagram view of a computer system constructed and operative in accordance with an embodiment of the present invention;

FIG. 2 is a flowchart including steps in a method of operation of a network device in the system of FIG. 1;

FIG. 3 is a flow diagram illustrating packet aggregation in a network device in the system of FIG. 1; and

FIG. 4 is a flowchart including steps in a method of operation of a host device in the system of FIG. 1.

### DESCRIPTION OF EXAMPLE EMBODIMENTS

### Overview

As previously mentioned, packet aggregation reduces the number of packets that a CPU has to process, which in turn reduces its utilization for networking. Currently, packet aggregation is not performed for secured, e.g., encrypted packets, for two reasons: (1) an inner flow of the packets (e.g., TCP packet sequence numbers) is hidden by the encryption; and (2) network device hardware lacks support for stateful operations performed per flow, such as replay protection updates.

Therefore, embodiments of the present invention, address at least some of the abovementioned drawbacks, by providing a network device, which receives an offload of cryptographic information (e.g., from a connected host device), receives secured packets encrypted using a per packet encryption protocol (e.g., Internet Protocol Security (IPsec), PSP Security Protocol, Datagram Transport Layer Security (DTLS), or Media Access Control Security (MACSec)), decrypts the received secured packets (without removing the security protocol header, e.g., if the packet is an IPSEC packet, the packet remains an IPSEC packet after decryption) based on the offloaded cryptographic information and/or data derived from the packet headers yielding multiple decrypted packets, and aggregates data from the multiple decrypted packets into an aggregated packet.

The network device may then present the aggregated packet to software running on the host device for further processing. For example, the network device may scatter the aggregated packet to memory (e.g., of the host device) for retrieval by the software running on the host device. In some embodiments, the network device may scatter the aggregated packet to a memory location indicated by a work queue entry (WQE) consumed by the aggregated packet.

The secured packets may include a security protocol header, a TCP header, and a TCP payload. The aggregated packet may include multiple TCP payloads inserted into the payload of the aggregated packet. The network device may encapsulate the payload of the aggregated packet with a TCP header, and a security protocol header, based on the TCP headers and security protocol headers of the decrypted packets aggregated into the aggregation packet. The TCP header and the security protocol header of the aggregation packet may include an indication of, or a list of, the security protocol packet sequence numbers and the TCP sequence numbers, respectively, of the packets aggregated into the aggregated packet.

In some embodiments, for example, where replay attack protection is performed by software running on the host device, the network device inspects the packet headers of the decrypted packets and only aggregates decrypted packets where the decrypted packets have sequential packet sequence numbers, e.g., security protocol sequence numbers, and/or TCP sequence numbers.

In some embodiments, the network device generates metadata about the aggregated packet. The metadata may indicate the packet sequence numbers of the packets aggregated into the aggregated packet and/or the number of packets aggregated into the aggregated packet. The metadata may also indicate the memory location(s) to which the aggregated packet has been (or will be) scattered in memory. The metadata may be included in a completion queue entry (CQE) written by the network device to a completion queue, e.g., in the memory, for reading by the software running on the host.

The software running on the host receives the aggregated packet (e.g., based on the metadata), decapsulates the packet of the security protocol header and the TCP header, and may perform any stateful operations in the encryption protocol layer, such as updating the replay protection map e.g., in IPSEC.

### System Description

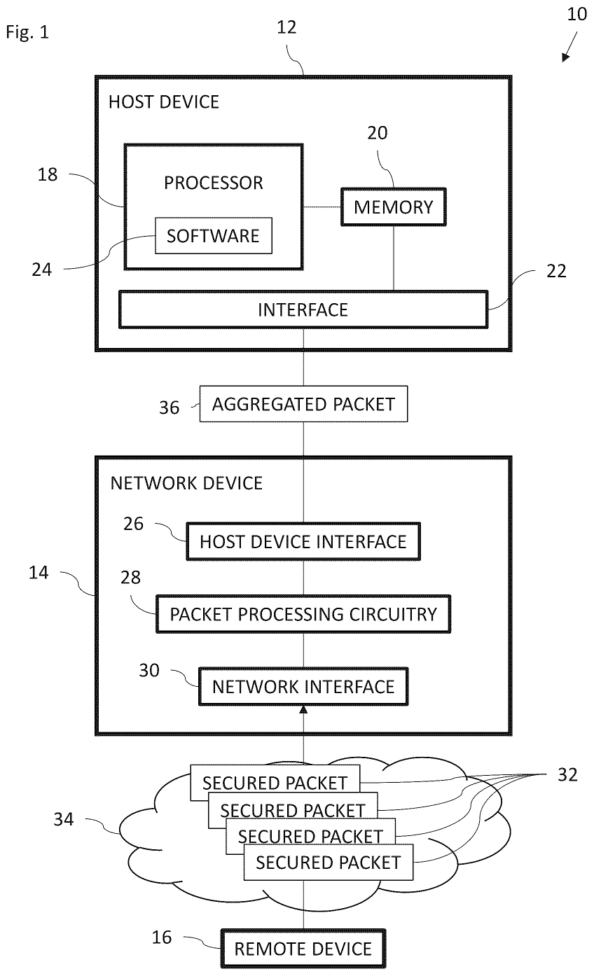

Reference is now made to FIG. 1, which is a block diagram view of a computer system 10 constructed and operative in accordance with an embodiment of the present invention. The computer system 10 includes a host device 12, a network device 14, and a remote device 16.

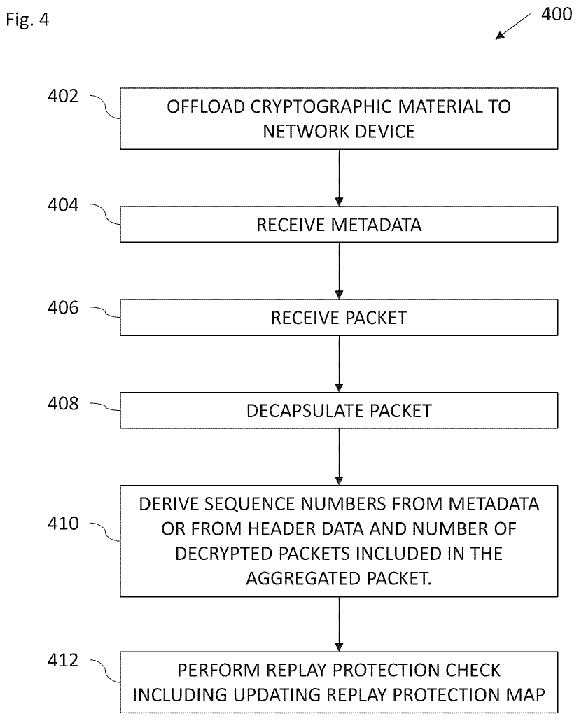

The host device 12 includes a processor 18, a memory 20, and an interface 22. The processor 18 is configured to execute software 24 described in more detail with reference to FIG. 4. The memory 20 is configured to store: data used by the processor 18; received packets for processing by the software 24; and queues such as a work queue including WQEs and a completion queue including CQEs. The interface 22 is configured to connect the host device 12 with the network device 14 for data sharing purposes. The interface 22 may operate according to any suitable protocol, for example, according to a data communication bus protocol, such as, Peripheral Component Interconnect Express (PCIe).

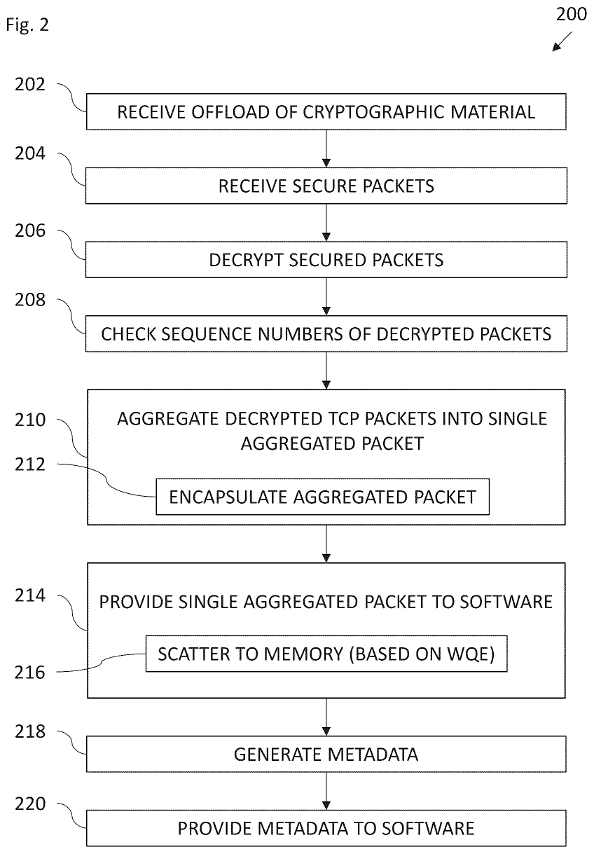

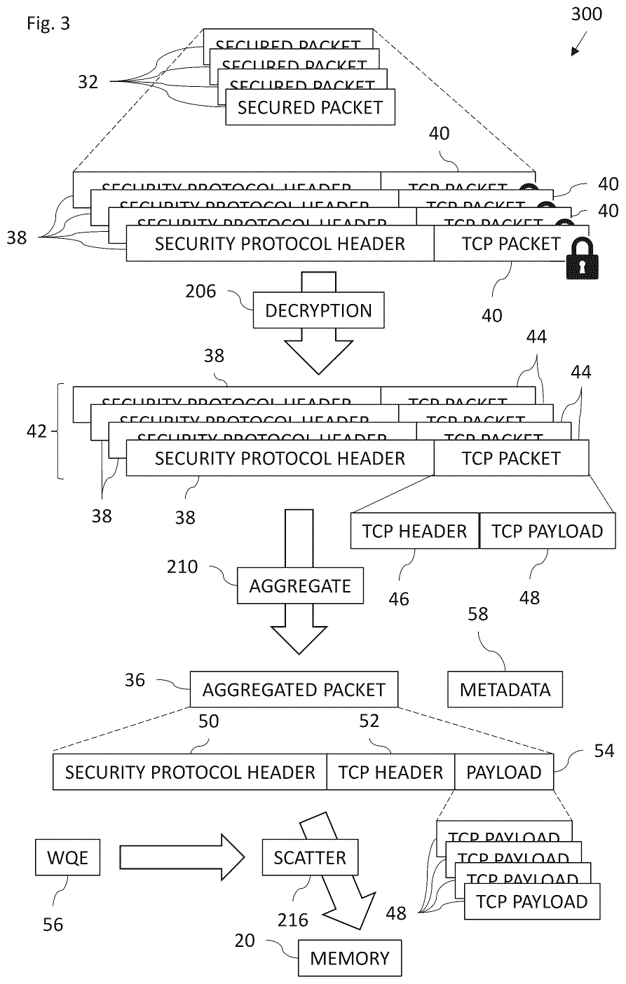

The network device 14 includes a host device interface 26, packet processing circuitry 28, and a network interface 30. The host device interface 26 is configured to connect the network device 14 to host device 12 for data sharing purposes, for example, according to a data communication bus protocol, such as, Peripheral Component Interconnect Express (PCIe). The network interface 30 is configured to receive secured packets 32 from the remote device 16 over a packet data network 34. The packet processing circuitry 28 is configured to decrypt the secured packets 32, and aggregate the decrypted packets into an aggregated packet 36, as described in more detail with reference to FIGS. 2 and 3. The packet processing circuitry 28 is configured to provide the aggregated packet 36 to the software 24 running on the processor 18 of the host device 12, for example, by scattering the aggregated packet 36 to memory, e.g., the memory 20, for retrieval by the software 24, as described in more detail with reference to FIG. 4.

Reference is now made to FIGS. 2 and 3. FIG. 2 is a flowchart 200 including steps in a method of operation of the network device 14 in the system 10 of FIG. 1. FIG. 3 is a flow diagram 300 illustrating packet aggregation in the network device 14 in the system 10 of FIG. 1. The packet processing circuitry 28 is configured to receive an offload of cryptographic material from the software 24 running on the processor 18 of the host device 12 (block 202).

The network interface 30 is configured to receive secured packets 32 from the remote device 16 over packet data network 34 (block 204). Each of the secured packets 32 is secured according to a security protocol and includes a respective security protocol header 38 and a secured (e.g., encrypted) Transmission Control Protocol (TCP) packet 40, which is encrypted according to the security protocol. The security protocol is generally a per packet encryption protocol. The security protocol may be any one of the following: Internet Protocol Security (IPsec); PSP Security Protocol; Datagram Transport Layer Security (DTLS); or Media Access Control Security (MACSec).

The packet processing circuitry 28 is configured to decrypt each of the secured packets 32 based on the respective security protocol header 38 yielding multiple decrypted packets 42 including decrypted TCP packets 44 (block 206). The decrypted packets 42 are still security protocol packets and include the respective security protocol headers 38. Each of the decrypted TCP packets 44 includes a TCP header 46 and a TCP payload 48. In some embodiments, the packet processing circuitry 28 is configured to decrypt the TCP packet 40 of each of the secured packets 32 based on the respective security protocol header 38 and the offloaded cryptographic material yielding the decrypted TCP packets 44.

The packet processing circuitry 28 is configured to check that packet sequence numbers (e.g., of the security protocol header 38 and/or the TCP header 46) of the multiple decrypted packets 42 form a sequence of consecutive numbers (block 208). In some embodiments, the packet processing circuitry 28 is configured to check that the sequence numbers in security protocol headers 38 and TCP headers 46 of the decrypted packets 42 form respective sequences of consecutive numbers (e.g., one consecutive sequence for the security protocol header 38 packet sequence numbers, and another consecutive sequence for the TCP header 46 packet sequence numbers).

In other embodiments, cryptographic replay protection and TCP window validation may also be offloaded by the software 24 to the packet processing circuitry 28 to perform replay attack protection. In these other embodiments, the packet processing circuitry 28 would indicate in metadata that the replay attack protection has been performed for the relevant packets. The software 24 may then determine whether to perform additional validation. In some cases, such as errors, software 24 may perform further checks and/or logging.

The packet processing circuitry 28 is configured to aggregate the decrypted TCP packets 42 into a single aggregated packet 36 (block 210). In some embodiments, the packet processing circuitry 28 is configured to aggregate the decrypted TCP packets 44 into the single aggregated packet 36 responsively to the sequence numbers (e.g., security protocol packet sequence numbers or TCP packet sequence numbers) of the multiple decrypted packets 42 forming a sequence of consecutive numbers. In some embodiments, the packet processing circuitry 28 is configured to aggregate the decrypted TCP packets 44 into the single aggregated packet 36 responsively to the sequence numbers in the security protocol headers 38 and the TCP headers 46 of the multiple decrypted packets 42 forming respective sequences of consecutive numbers.

The packet processing circuitry 28 is configured to encapsulate the aggregated packet 36 with a given security protocol header 50 and a given TCP header 52 based on the security protocol headers 38 and the TCP header 46 of the decrypted packets 42 (block 212). The aggregated packet 36 therefore includes the security protocol header 50, the TCP header 52, a payload 54 comprising the TCP payloads 48 of the decrypted packets 42. The security protocol header 50 may indicate the packet sequence numbers included in the security protocol headers 38 of the decrypted packets 42 aggregated into the aggregated packet 36. The security protocol header 50 may also include other information common to the security protocol headers 38 of the decrypted packets 42 aggregated into the aggregated packet 36. The TCP header 52 may indicate the packet sequence numbers included in the TCP headers 46 of the decrypted packets 42 aggregated into the aggregated packet 36. The TCP header 52 may also include other information common to the TCP headers 46 of the decrypted packets 42 aggregated into the aggregated packet 36 such as Source Port, Destination Port, Acknowledgement Number, Header Length, Window Size, Flags, TCP Checksum, and Urgent Pointer.

The packet processing circuitry 28 is configured to provide the single aggregated packet 36 to the software 24 running on the processor 18 of the host device 12 via the host device interface 26 (block 214). In some embodiments, the packet processing circuitry 28 is configured to scatter the single aggregated packet 36 to the memory 20 of the host device 12 accessible by the software 24 (block 216). In some embodiments, the packet processing circuitry 28 is configured to scatter the single aggregated packet 36 to the memory 20 according to a memory location given by a work queue entry (WQE) 56 consumed by the single aggregated packet 36. In other embodiments, the packet processing circuitry 28 may scatter the aggregated packet 36 to the memory 20 without using a WQE.

The packet processing circuitry 28 is configured to generate metadata 58 about the number of decrypted TCP packets 44 comprised in the single aggregated packet 36 (block 218), and provide the metadata 58 to the software 24 running on the processor 18 of the host device 12 (block 220). In some embodiments, the packet processing circuitry 28 is configured to generate the metadata 58 with an indication of the sequence numbers (e.g., security protocol packet sequence numbers and/or TCP packet sequence numbers) of the decrypted packets 42 comprised in the single aggregated packet 36. In some embodiments, the metadata 58 may be provided to the software 24 using a completion queue entry (CQE) indicating completion processing of the aggregated packet 36 by the packet processing circuitry 28. In some embodiments, the indication of the sequence numbers (e.g., the sequence number of the first decrypted packet 42 included in the aggregated packet 36) may be added to header data of the aggregated packet 36.

In practice, some or all of these functions of the packet processing circuitry 28 may be combined in a single physical component or, alternatively, implemented using multiple physical components. These physical components may comprise hard-wired or programmable devices, or a combination of the two. In some embodiments, at least some of the functions of the packet processing circuitry 28 may be carried out by a programmable processor under the control of suitable software. This software may be downloaded to a device in electronic form, over a network, for example. Alternatively, or additionally, the software may be stored in tangible, non-transitory computer-readable storage media, such as optical, magnetic, or electronic memory.

Reference is now made to FIG. 4, which is a flowchart 400 including steps in a method of operation of the host device 12 in the system 10 of FIG. 1. The software 24 running on the processor 18 of the host device 12 is configured to: offload cryptographic material to the network device 14 (block 402); receive the metadata 58 (e.g., in a CQE) (block 404); receive the single aggregated packet 36 (block 406) for example, based on location(s) included in the metadata 58; decapsulate the security protocol header 50 (and the TCP header 52) from the aggregated packet 36 (block 408); derive security protocol sequence numbers of decrypted packets 42 from: the metadata 58 of the aggregated packet 36; or from header data of the single aggregated packet 36 and a number of decrypted packets 42 included in the single aggregated packet 36 (block 410), and perform replay protection check(s) (e.g., based on the packet sequence number data included in the metadata 58, security protocol header 50 and/or the TCP header 52) and update a replay protection map based on security protocol sequence numbers (and/or the TCP packet sequence numbers) of the decrypted packets 42 included in the single aggregated packet 36 and/or the metadata 58 (block 412).

Various features of the invention which are, for clarity, described in the contexts of separate embodiments may also be provided in combination in a single embodiment. Conversely, various features of the invention which are, for brevity, described in the context of a single embodiment may also be provided separately or in any suitable sub-combination.

The embodiments described above are cited by way of example, and the present invention is not limited by what has been particularly shown and described hereinabove. Rather the scope of the invention includes both combinations and sub-combinations of the various features described hereinabove, as well as variations and modifications thereof which would occur to persons skilled in the art upon reading the foregoing description and which are not disclosed in the prior art.

What is claimed is:

1. A network device, comprising:
a network interface to receive secured packets from a remote device over a packet data network, each of the secured packets being secured according to a security protocol and including a respective security protocol header and a Transmission Control Protocol (TCP) packet, which is encrypted according to the security protocol;
a host device interface to connect the network device to a host device; and
packet processing circuitry to:
decrypt each of the secured packets based on the respective security protocol header yielding multiple decrypted packets including decrypted TCP packets;
aggregate the decrypted TCP packets into a single aggregated packet; and
provide the single aggregated packet to software running on a processor of the host device via the host device interface.

2. The device according to claim 1, wherein the aggregated packet is encapsulated with a given security protocol header and a given TCP header.

3. The device according to claim 1, wherein the packet processing circuitry is to scatter the single aggregated packet to a memory of the host device accessible by the software.

4. The device according to claim 3, wherein the packet processing circuitry is to scatter the single aggregated packet to the memory according to a memory location given by a work queue entry consumed by the single aggregated packet.

5. The device according to claim 1, wherein the security protocol is a per packet encryption protocol.

6. The device according to claim 5, wherein the security protocol is any one of the following: Internet Protocol Security (IPsec); PSP Security Protocol; Datagram Transport Layer Security (DTLS); or Media Access Control Security (MACSec).

7. The device according to claim 1, wherein packet processing circuitry is to:
check that sequence numbers of the multiple decrypted packets form a sequence of consecutive numbers; and
aggregate the decrypted TCP packets into the single aggregated packet responsively to the sequence numbers of the multiple decrypted packets forming a sequence of consecutive numbers.

8. The device according to claim 7, wherein the packet processing circuitry is to:
check that the sequence numbers in security protocol headers and TCP headers of the decrypted packets form respective sequences of consecutive numbers; and
aggregate the decrypted TCP packets into the single aggregated packet responsively to the sequence numbers in the security protocol headers and the TCP headers of the multiple decrypted packets forming respective sequences of consecutive numbers.

9. The device according to claim 7, wherein the packet processing circuitry is to:
generate metadata about the number of decrypted TCP packets comprised in the single aggregated packet; and
provide the metadata to the software running on the processor of the host device.

10. The device according to claim 9, wherein the packet processing circuitry is to generate the metadata with an indication of the sequence numbers of the decrypted packets comprised in the single aggregated packet.

11. The device according to claim 1, wherein the packet processing circuitry is to:
receive an offload of cryptographic material from the software running on the processor of the host device; and
decrypt the TCP packet of each of the secured packets based on the respective security protocol header and the offloaded cryptographic material yielding the decrypted TCP packets.

12. A system comprising:
the network device of claim 1; and
the host device, wherein the software is to:
receive the single aggregated packet; and
decapsulate the given security protocol header from the aggregated packet.

13. The system according to claim 12, wherein the software is to update a replay protection map based on security protocol sequence numbers of the decrypted packets included in the single aggregated packet.

14. The system according to claim 13, wherein the software is to derive the security protocol sequence numbers from: metadata of the single aggregated packet; or header data of the single aggregated packet and a number of decrypted packets included in the single aggregated packet.

15. A method, comprising:
receiving secured packets from a remote device over a packet data network, each of the secured packets being secured according to a security protocol and including a respective security protocol header and a Transmission Control Protocol (TCP) packet, which is encrypted according to the security protocol;
decrypting each of the secured packets based on the respective security protocol header yielding multiple decrypted packets including decrypted TCP packets;
aggregating the decrypted TCP packets into a single aggregated packet; and
providing the single aggregated packet to software running on a processor of a host device via a host device interface.

16. The method according to claim 15, wherein the aggregated packet is encapsulated with a given security protocol header and a given TCP header.

17. The method according to claim 15, further comprising scattering the single aggregated packet to a memory of the host device accessible by the software.

18. The method according to claim 17, wherein the scattering includes scattering the single aggregated packet to the memory according to a memory location given by a work queue entry consumed by the single aggregated packet.

19. The method according to claim 15, wherein the security protocol is a per packet encryption protocol.

20. The method according to claim 19, wherein the security protocol is any one of the following: Internet Protocol Security (IPsec); PSP Security Protocol; Datagram Transport Layer Security (DTLS); or Media Access Control Security (MACSec).

21. The method according to claim 15, further comprising checking that sequence numbers of the multiple decrypted packets form a sequence of consecutive numbers, and wherein the aggregating includes aggregating the decrypted TCP packets into the single aggregated packet responsively to the sequence numbers of the multiple decrypted packets forming a sequence of consecutive numbers.

22. The method according to claim 21, wherein:
the checking includes checking that the sequence numbers in security protocol headers and TCP headers of the decrypted packets form respective sequences of consecutive numbers; and
the aggregating includes aggregating the decrypted TCP packets into the single aggregated packet responsively to the sequence numbers in the security protocol headers and the TCP headers of the multiple decrypted packets forming respective sequences of consecutive numbers.

23. The method according to claim 21, further comprising:
generating metadata about the number of decrypted TCP packets comprised in the single aggregated packet; and
providing the metadata to the software running on the processor of the host device.

24. The method according to claim 23, wherein the generating includes generating the metadata with an indication of the sequence numbers of the decrypted packets comprised in the single aggregated packet.

25. The method according to claim 15, further comprising receiving an offload of cryptographic material from the software running on the processor of the host device, wherein the decrypting includes decrypting the TCP packet of each of the secured packets based on the respective security protocol header and the offloaded cryptographic material yielding the decrypted TCP packets.

26. The method according to claim 15, further comprising:
receiving the single aggregated packet; and
decapsulating the given security protocol header from the aggregated packet.

27. The method according to claim 26, further comprising updating a replay protection map based on security protocol sequence numbers of the decrypted packets included in the single aggregated packet.

28. The method according to claim 27, wherein the software is to derive the security protocol sequence numbers from: metadata of the single aggregated packet; or header data of the single aggregated packet and a number of decrypted packets included in the single aggregated packet.
